(19) United States
(12) Patent Application Publication
(10) Pub. No.: US 2015/0070918 A1
(43) Pub. Date: Mar. 12, 2015

(54) ADAPTER FOR LED MODULES OF THE PACKAGE/ARRAY TYPE

(71) Applicant: A.A.G. STUCCHI S.R.L., Olginate (IT)

(72) Inventor: Antonietta Stucchi, Olginate (IT)

(73) Assignee: A.A.G. STUCCHI S.R.L., Olginate (IT)

(21) Appl. No.: 14/391,586

(22) PCT Filed: Apr. 10, 2013
(86) PCT No.: PCT/EP2013/057507

§ 371 Date: Oct. 9, 2014

(30) Foreign Application Priority Data
Apr. 13, 2012 (IT) MI2012U000150

(51) Int. Cl. F21V 29/00; F21V 19/00

(52) U.S. Cl. CPC F21V 29/22; F21V 19/0015; F21Y 2101/02
USPC 362/457

(57) ABSTRACT

An adapter for LED module of the package/array type comprising an adapter body that is adapted to allow the accommodation of an LED package/array of a non-standardized type, the adapter body being able to be associated with a heat sink.

The present invention relates to an adapter for LED modules. More particularly, the invention relates to an adapter for LED modules of the package/array type.

As is known, circular LED modules are commercially available whose space occupation and mounting dimensions comply with a very specific standard. The LEDs are already mounted inside the modules.

This allows interchangeability among the various modules of various manufacturers that comply with the standard.

In addition to LEDs, modules of the known type can have internally, soldered to the printed circuit, other electronic assemblies, which, connected to each other, allow receiving commands for the management of the LEDs (for example adjustment of light, color, etc.) and sending data for monitoring the internal temperature.

The circular module compliant with the above-cited standard is fixed by means of screws in a heat sink with the interposition of a heat dissipation interface. Since the fixing distances are standardized, it is possible to use modules of different manufacturers and having different luminous characteristics with a same type of heat sink, therefore with preset heat sink holes.

However, high-brightness LEDs, known as packages, arrays etc., having a substantially square or rectangular shape also are commercially available and might be used as an alternative to the circular modules compliant with the standard cited above, in the same lighting systems, fixed to a heat sink.

However, these modules, by not being standard-compliant, would not be compatible and interchangeable with the modules that meet the standard cited above.

The aim of the present invention is to provide an adapter for LED modules that allows rendering non-standardized LED modules of the type cited above interchangeable with standard-compliant circular LED modules.

Within this aim, an object of the present invention is to provide an adapter that allows using square LED modules on the heat sink that would be used with standard LED modules.

Another object of the present invention is to provide an adapter that is highly reliable, relatively simple to provide and has low costs.

This aim, as well as these and other objects that will become more apparent hereinafter, are achieved by an adapter for LED modules, characterized in that it comprises an adapter body that is adapted to allow the accommodation of an LED module of a non-standardized type, said adapter body being able to be associated with a heat sink.

Further characteristics and advantages of the invention will become more apparent from the description of a preferred not exclusive embodiment of the adapter according to the invention, illustrated by way of non-limiting example in the accompanying drawings, wherein:

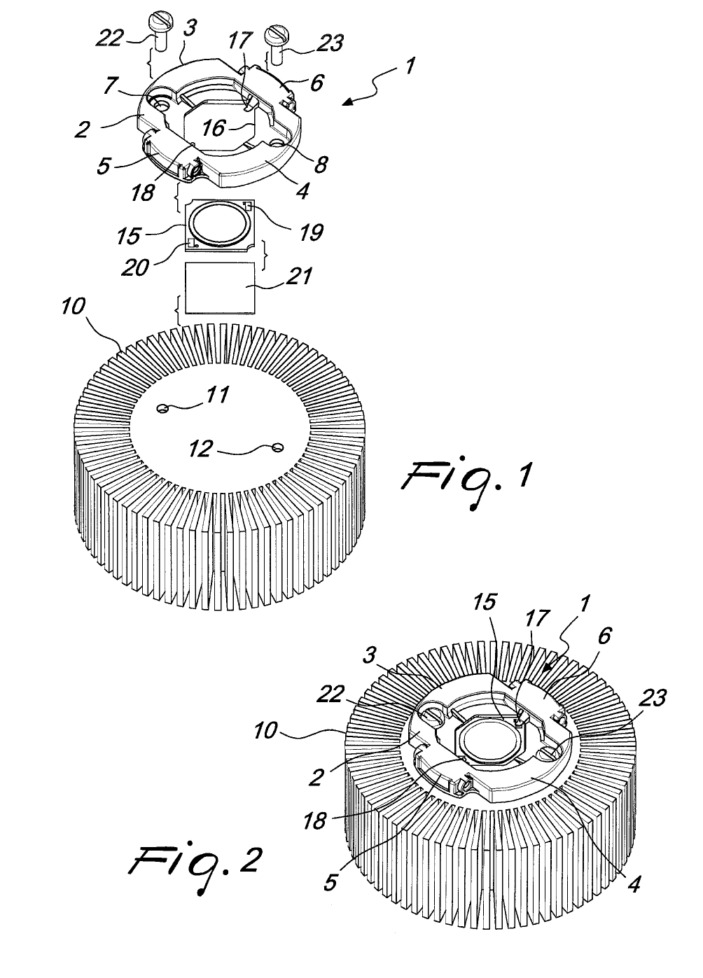

FIG. 1 is an exploded perspective view of an adapter according to the invention, of a corresponding LED module and of a heat sink;

FIG. 2 is a perspective view of the heat sink with the adapter and the corresponding LED package/array according to the invention mounted thereon;

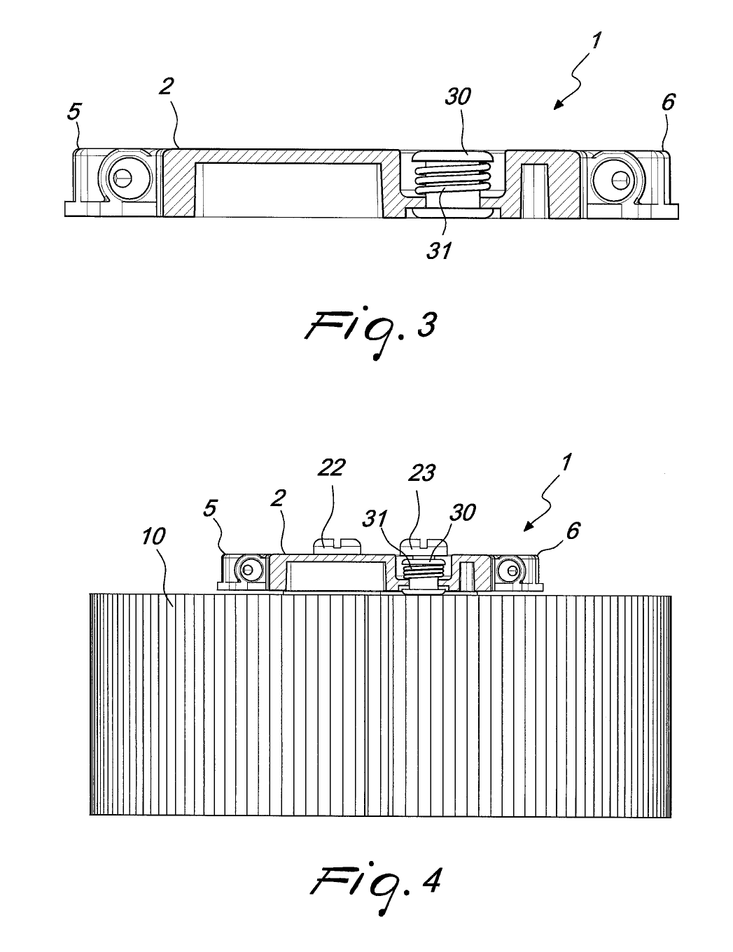

FIG. 3 is a sectional view of a variation of the adapter shown in FIG. 1; and

FIG. 4 is a sectional view of the adapter of FIG. 3 with the LED package/array mounted on the heat sink.

With reference to the figures, the adapter according to the invention, designated by the reference numeral 1, comprises a body 2 that has a substantially circular shape or, if it has a rectangular or square shape, has rounded ends 3 and 4, and connectors for wires 5 and 6 that are arranged mutually opposite at the longer sides of the body 2.

Conveniently, the body 2 is shaped so as to have at least two fixing holes 7 and 8, which allow fixing the body 2 to a heat sink 10, at holes 11 and 12 that are present respectively on the upper face of the heat sink 10.

In this manner, the body 2 can be coupled to the heat sink 10 with a connection that is standardized as regards the position of the holes. The body 2 allows accommodation of an LED package/array 15 inside it that does not have the standard circular shape but is of the package/array type. In this manner, the package/array 15 can be substantially rendered standard in fixing to the heat sink 10 thanks to the presence of the adapter 1.

Moreover, the body 2 of the adapter 1 is provided internally with a cavity 16 whose perimetric profile has various shapes that however are commonly rectangular or square or hexagonal and allows accommodating the package/array 15 inside it and providing electrical contacts with the module 15 by means of metallic tabs 17 and 18 that protrude toward the inside of the cavity 16 and make contact with connecting pads 19 and 20, respectively, the LED package/array 15.

Conveniently, a conventional thermal interface module 21 is provided between the body 2 (and the corresponding LED module 15 mounted thereon) and the heat sink 10.

FIG. 2 is a view of the assembly of the adapter 1 with the corresponding LED package/array 15 standardized in its mounting dimensions thanks to the presence of the adapter 1.

The fixing of the adapter 1 to the heat sink 10 is provided by means of screws 22 and 23 that engage in the holes 7 and 8 respectively of the body 2 of the adapter 1 and are screwed in the holes 11 and 12, respectively in the heat sink 10.

FIG. 3 is a view of a constructive variation of the body 2 of the adapter 1, wherein in the holes 7 and 8 of the body 2 there are two rivets 30 inserted in the two holes of the adapter, elastic means 31 being interposed between the upper head of said rivets and the wall of the mounting hole.

The screws 22 and 23 are made to pass through the rivets 30 and allow fixing the adapter 1 to the heat sink 10. This allows the adapter 1 to have a vertical motion that allows pushing the LED package/array 15 through the interface 21 to the heat sink 10, ensuring good and constant pressure.

When the adapter 1 is mounted over the LED package/array 15 inserted with the screws 22 and 23 in the heat sink 10, the body 2 of the adapter 1 rises and, by compressing the spring 31 that is fitted in the mounting holes 7 and 8 between the body 2 of the adapter 1 and the head of the rivet 30, it applies pressure to the upper surface of the LED module 15, pushing it against the thermal dissipation interface 21 and the heat sink 10.

FIG. 4 is a view of the adapter of FIG. 3 assembled in the heat sink 10.

In practice it has been found that the adapter according to the invention fully achieves the intended aim and objects, since it allows standardizing the use of package/array LED modules that have a different shape than modules of the standard type, despite using heat sink elements with holes that are standardized as regards their dimensions and position.

This allows using LED package/arrays of various types, thus rendering them mutually interchangeable.

Moreover, all the details may be replaced with other technically equivalent elements.

In practice, the materials used, as well as the contingent shapes and dimensions, may be any according to the requirements and the state of the art.

The disclosures in Italian Utility Model Application No. MI2012U000150 from which this application claims priority are incorporated herein by reference.

1-7. (canceled)

8. An adapter for LED modules of the package/array type, comprising an adapter body that is adapted to allow the accommodation of an LED package/array of a non-standardized type, said adapter body being able to be associated with a heat sink.

9. The adapter according to claim 8, wherein said adapter body has an internal cavity adapted to accommodate said non-standardized LED package/array.

10. The adapter according to claim 9, wherein said internal cavity is shaped so as to conform to the shape of the LED package/array that is mounted.

11. The adapter according to claim 8, wherein said body has at least two holes for fixing by means of screws said body to the heat sink.

12. The adapter according to claim 9, wherein said body comprises a pair of tabs that protrude toward the inside of said cavity and are adapted to make contact with connecting pads provided on said non-standardized LED package/array.

13. The adapter according to claim 11, further comprising, in at least said two holes for the fixing of said body to said heat sink, rivets between the head of which and the hole wall elastic means are provided.

14. The adapter according to claim 8, wherein said non-standardized LED package/array is an LED package/array of the rectangular and/or the square type.
